(19) United States
(12) Patent Application Publication
(10) Pub. No.: US 2019/0113938 A1
(43) Pub. Date: Apr. 18, 2019

(54) AUTOMATIC SYSTEM FOR SHOWERING DEVICES

(71) Applicants: Ka Shek Neville LEE, Hong Kong (CN); Sing-kwong Samuel HUI, Hong Kong (CN)

(72) Inventors: Ka Shek Neville LEE, Hong Kong (CN); Sing-kwong Samuel HUI, Hong Kong (CN)

(21) Appl. No.: 16/306,537

(22) PCT Filed: Jun. 9, 2017
(86) PCT No.: PCT/CN2017/087759

§ 371 Date: Nov. 30, 2018

Related U.S. Application Data
(60) Provisional application No. 62/348,172, filed on Jun. 10, 2016.

(51) Int. Cl. G05D 27/02; G05D 23/19; A47K 3/28

(52) U.S. Cl. CPC G05D 27/02; A47K 3/28; G05D 23/1917

(57) ABSTRACT

Disclosed is an automatic system for showering devices, comprising means for personalizing a showering program to a specific user or profile, selective control of shower nozzles or water dispensers dedicated to different portions of the body, means for digitally sensing and controlling the temperature of water or air, and an adjustable drainage disposal system. The adjustable drainage disposal system may optionally comprise means for pumping waste water up to a toilet, receptacle or to a drain.

### CROSS-REFERENCE TO RELATED APPLICATION

This application claims the benefit of U.S. provisional application No. 62/348,172 filed Jun. 10, 2016. The entire disclosure of the above-referenced application is incorporated herein by reference in entirety for all purposes.

### FIELD OF THE INVENTION

The present disclosure relates to an automatic system for showering devices, particularly to an automatic system for showering devices with means for personalizing a showering program to a specific user or profile, selective control of shower nozzles dedicated to different portions of the body, control over the heating or cooling of the body and a drainage disposal system. A diagnostic system also helps to ensure that installation and operation of the system are smooth.

### BACKGROUND OF THE INVENTION

In the prior art there are many examples of bathing equipment used to bathe a frail or elderly individual. These can span from shower chairs, walk-in bathtubs to showers with swinging shower heads.

Unfortunately, in a nursing home or hospital environment, bathing is very time consuming and these products fail to simplify or reduce the resource requirements (especially manpower). To really save time and resources, the device needs to provide a comprehensive range of bathing functions such as temperature maintenance, safety, soaping, disinfecting and drying. Furthermore, a user may only want some of these functions so it must be adjustable yet remain simple to use for seniors.

### SUMMARY OF THE INVENTION

It is thus a first goal of this disclosure to provide an automatic system for showering devices that is easy to use, but still configurable, covers a wide range of bathing functions and yet has safety features to prevent misuse, injury or scalding.

A second goal of this disclosure is to prevent thermal shock. A sudden change in bathing temperature, residual cold water in the pipes or delay in transition between washing and drying can all cause a burden on the heart or exasperate respiratory conditions.

Prior arts such as U.S. Pat. No. 3,587,118A introduce a system with both a bath and a dryer. Unfortunately, in these systems the bathing and drying process are separate and discrete processes with absolutely no coordination between the two to prevent a sudden change in temperature or thermal shock. This is also the case with U.S. Pat. No. 4,425,672A.

Thus, it is a second goal of the current invention to introduce an automatic showering system that attempts to minimize the risk of cardiac arrest and improve the comfort of the user by carefully managing the showering process and temperature profiles from all the way before showering, during showering and after showering.

A third goal of this disclosure is to provide a reliable product with diagnostic tools to make it easy to install, maintain and check whether operations are running smoothly. Certain diagnostics tools can also be used to check on the user's body conditions.

Furthermore, to improve on the showering process, the showering system may make use of the diagnostic data to adapt or learn from a user's showering history, minimize thermal shock, make showering recommendations based on a knowledge base, body conditions or environmental conditions. It should also be able to sense a user's body or skin conditions, provide safety alerts and safety controls to prevent harm to the user.

It is the goal of the present invention to provide an automatic system for showering that handles the aforementioned issues, provides diagnostics to maintain bathing performance and significantly lends aid to the bathing process.

### BRIEF DESCRIPTION OF THE DRAWINGS

FIG. 1 depicts the bathing function selection process for both manual and automatic bathing.

FIG. 2 illustrates how a thermal management system may operate.

FIG. 3 illustrates how a system or setup diagnostic system may operate.

FIG. 4 illustrates how a health or body diagnostic system may operate.

### DETAILED DESCRIPTION OF THE INVENTION

The present disclosure introduces an automatic system for showering devices that comprises means for personalizing a showering program to a specific user or profile, selective control of shower nozzles or water dispensers dedicated to different portions of the body, means for digitally sensing and controlling the temperature of water or air, and an adjustable drainage disposal system. The adjustable drainage disposal system may optionally comprise means for pumping waste water up to a toilet, receptacle or to a drain.

The aim of this automatic system is to be holistic, and must provide a range of bathing functions, preferably including washing of specific regions, temperature control, soaping, drying and system disinfection. To be widely used, it would preferably be operable both manually (function by function, automatically (to a profile or setting), easy to use and configurable.

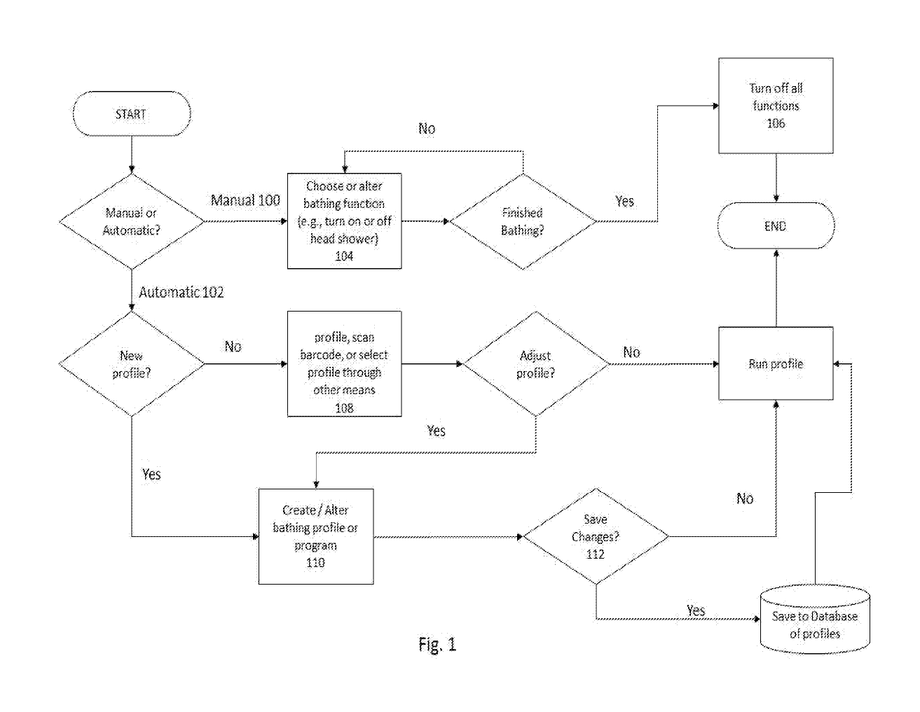

In FIG. 1, we detail this holistic bathing approach with both a manual 100 and automatic 102 approaches. Regardless of the approach, preferably it can be operated quickly and simply through simple key input, selection of profile or user recognition.

The user may choose whether to manually call individual bathing functions 104. For example, if they choose the manual option, they may press a button to turn on the head shower nozzle, or another to adjust the temperature. Alternatively, the user may push a button to turn on the foot nozzles, bidet or to add soap. To turn off the bathing function in the manual mode, preferably the user presses the button a second time. Alternatively, the bathing function can be turned off after a predefined time. Bathing is completed when all the functions are turned off.

In the automatic mode, optionally the user specifies a profile or selection of the profile that can be based on some sort of user recognition like a bar code, ID, facial recognition, etc., for quick and simple operation 108. Preferably the bathing profile will control the bathing time, functions, zones and temperatures (water and possibly air). Alternatively, there is the option to alter an existing profile or create a new one 110. More preferably this bathing profile can be configured and saved for later recall 112.

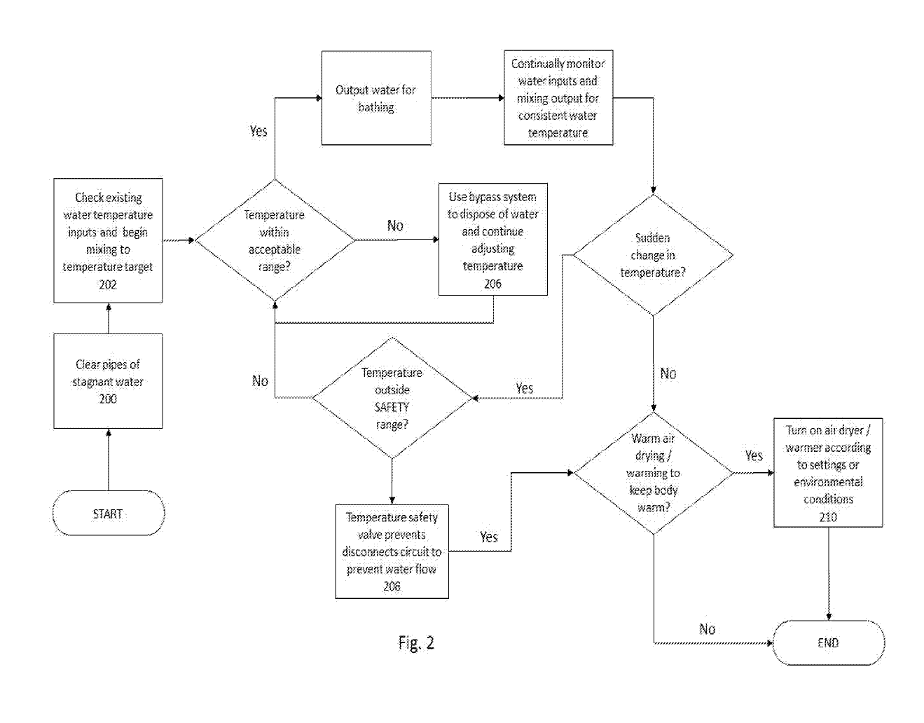

In a second aspect of the invention, as shown in FIG. 2, preferably there is a thermal management system to prevent thermal shock or scalding. The thermal management system may first clear out any residual or stagnant water in the pipes or shower nozzles 200. This is because this water may have cooled down and could provide “jolt” or “shock” to the body. A water mixer, heater or regular then mixes the water to a target temperature 202 or acceptable temperature range 204. Optionally there is a buffer system to smoothen out the water temperature to ensure that sudden temperature spikes are more manageable. Optionally there is a bypass system so that water that does not meet the temperature or quality standard can be disposed of without passing through the shower nozzles 206. When the temperature is located in the acceptable range, the showering device outputs water for bathing. During the whole shower process, the water input and mixing output are continually monitored for consistent water for consistent temperature. Preferably there is also an emergency temperature valve 208 for preventing water that is outside the safety limits to pass through the shower nozzles. Once there is any sudden change in temperature, the emergency temperature valve 208 may disconnect circuit to prevent water flow. To prevent thermal shock, the thermal management system preferably manages air and water temperature to minimize a change in body or skin temperature when changing from a dry to a wet state or back to a dry 210. This can be managed through the adjustment of water and air temperature (through an optional dryer or heater). If the sudden change does not cause the temperature outside the safety range, the system may further determine whether the changed temperature is within acceptable range and then repeat the aforementioned steps.

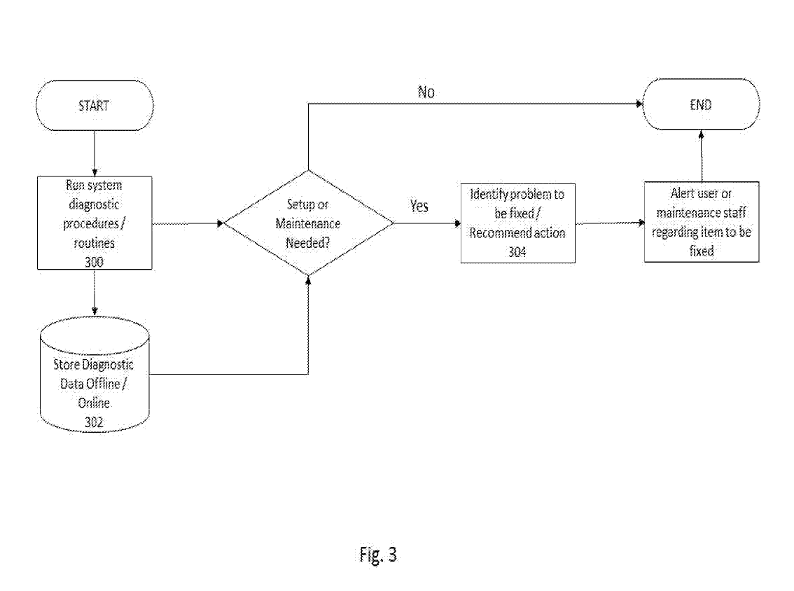

In a third aspect of the invention, as shown in FIG. 3, preferably there is a diagnostic system that can be used to identify any installation or operational problems. Optionally this diagnostic program can be operated during installation and regularly at intervals 300 and the diagnostic system may comprise sensors for measuring water pressure, temperature, pipe blockage, or whether the device is properly grounded for safety. This information can be stored in a database either offline 302 on the device or tablet, or online (cloud).

Many nursing homes and hospitals are concerned about down time, so the diagnostic system can provide confirmation of proper set-up, easy identification of problems 304, and early warning of potential problems. This information would be useful for maintenance purposes such as notifying, alerting and identifying the need for service and what to fix.

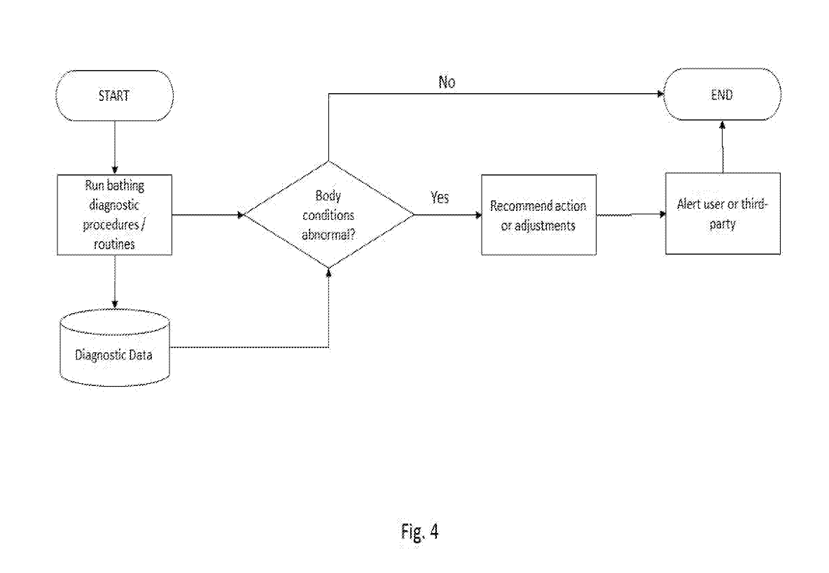

More preferably the diagnostic system may also comprise sensors to monitor the body conditions, as shown in FIG. 4 of the user such as blood pressure, skin conditions, etc. Changes to the bathing profile or follow-up actions can then be recommended. This diagnostic data would also be useful for the institution and hospital data keeping records.

In order to make all the aforementioned systems work, preferably there comprises means for accessing the Internet or external device, sending an external message or updating a system or knowledge bank of information. More preferably there comprises an input, interaction or control mechanism such as buttons, a touch screen, external device, remote, gesture recognition, barcode, sensor reading, person recognition or voice recognition. Optionally there comprises a microprocessor and memory storage.

In another aspect of the invention, the automatic system for bathing may also comprise an electronic or automatic patient transfer system or movement device such as an AGV or electric wheelchair.

While various embodiments of the present invention have been described in detail, it is apparent that modifications and alterations of those embodiments will occur to those skilled in the art. However, it is expressly understood that such modifications and alterations are within the scope and spirit of the present invention, as set forth in the following claims. Further, the invention(s) described herein are capable of other embodiments and being practiced or of being carried out in various ways. In addition, it is to be understood that the phraseology and terminology used herein is for the purposes of description and should not be regarded as limiting. The use of “including”, “comprising” and variations thereof herein are meant to encompass the items listed thereafter and equivalents thereof, as well as, additional items.

What is claimed is:

1. An automatic system for showering devices comprising:
a. means for personalizing a showering program to a specific user or profile,
b. selective control of shower nozzles or water dispensers dedicated to different portions of the body,
c. means for digitally sensing and controlling the temperature of water or air, and
d. an adjustable drainage disposal system;
wherein the showering device provides a sitting part for users and the showering device acts to automatically wash the different portions of the body at specific intervals, times and temperature.

2. The automatic system for showering devices as claimed in claim 1 comprising means for quick operation through simple key input, selection of profile or user recognition.

3. The automatic system for showering devices as claimed in claim 1 wherein said showering program comprises means for configuring or setting bath time, bath functions and water temperature and saving them for recall.

4. The automatic system for showering devices as claimed in claim 3 wherein said bath functions include washing of different portions of the body, a bidet, soaping, system disinfection or drying.

5. The automatic system for showering devices as claimed in claim 1 including a diagnostic system for identifying the state or changes to the showering device, performance, user's body or the environment.

6. The automatic system for showering devices as claimed in claim 5 wherein said diagnostic system is capable of detecting water pressure, pipe blockage, grounding of electricity.

7. The automatic system for showering devices as claimed in claim 5 comprising a smart system capable of providing alerts, provide recommendations, carry out an instruction, or adapt said showering program in response to data from the diagnostic system or from a knowledge bank.

8. The automatic system for showering devices claimed in claim 1 comprising a thermal management system for measuring and regulating water or air temperature, or for managing the transition between two temperatures.

9. The automatic system for showering devices as claimed in claim 8 wherein said thermal management system comprises a buffer system for smoothening out sudden water temperature spikes.

10. The automatic system for showering devices as claimed in claim 8 wherein said thermal management system comprises a bypass system for bypassing the shower nozzles and disposing unwanted or excessively hot or cold water.

11. The automatic system for showering devices as claimed in claim 8 wherein said thermal management system comprises a temperature valve, wherein excessive high or low temperatures will trigger the temperature valve and utilize said bypass system for disposing the water.

12. The automatic system for showering devices as claimed in claim 1 comprising means for accessing the Internet or external device, sending an external message or updating a system or knowledge bank of information.

13. The automatic system for showering devices as claimed in claim 1 comprising an input, interaction or control mechanism including buttons, a touch screen, external device, remote, gesture recognition, barcode, sensor reading, person recognition or voice recognition.

14. The automatic system for showering devices as claimed in claim 1 comprising means for controlling or providing power to an external device.

15. The automatic system for showering devices as claimed in claim 1 comprising a microprocessor and a memory storage.

16. The automatic system for showering devices as claimed in claim 1 comprising means for controlling an electronic patient transfer or movement device including an AGV, wheelchair.

17. The automatic system for showering devices as claimed in claim 1 wherein said adjustable drainage disposal system comprises means for pumping waste water up to a toilet, receptacle or to a drain.
